(19) United States
(12) Patent Application Publication
(10) Pub. No.: US 2023/0169329 A1
(43) Pub. Date: Jun. 1, 2023

(54) METHOD TO INCORPORATE UNCERTAIN INPUTS INTO NEURAL NETWORKS

(71) Applicant: NVIDIA Corporation, Santa Clara, CA (US)

(72) Inventors: Fabio Tozeto Ramos, Seattle, WA (US); Rika Antonova, Menlo Park, CA (US); Ankur Handa, Seattle, WA (US); Dieter Fox, Seattle, WA (US)

(21) Appl. No.: 17/540,107

(22) Filed: Dec. 1, 2021

(51) Int. Cl. G06N 3/08

(52) U.S. Cl. CPC G06N 3/08

(57) ABSTRACT

Systems and methods related to incorporating uncertain inputs into a neural network are described herein. A distribution is obtained and processed by a Reproducing Kernel Hilbert Space (RKHS) module to generate an embedding that represents the distribution. The features of the embedding may correspond to a number of Random Fourier Features (RFFs). The embedding can be added to additional features to form an aggregate input for the neural network. The neural network then processes the aggregate input to generate an output based on, at least in part, the embedding of the distribution. In some embodiments, a simulation can be run to generate a distribution for a feature, where each simulator instance generates a different sample for the feature over a plurality of time steps of the simulation. In some embodiments, the output neural network can be used to control robotic systems, vehicles, or other systems.

### BACKGROUND

Deep learning with neural networks has been successfully applied across many different applications. Neural networks can be considered a main tool for combined feature learning and high-level reasoning. However, the success of using neural networks is primarily based on problems where the input feature set is deterministic.

For example, in image processing applications, an input image having specific values for each of the pixels is analyzed by a convolutional neural network (CNN) to detect an object in the image. In this case, the pixel values are all specified within the image data structure. As another example, a text document is processed to determine semantic labels associated with different portions of the text. In this case, the characters in the text document are identified in the document. However, there are many problems in which the feature set provided to the inputs of the neural network may be unknown. In some cases, while certain features may be unknown, the range of possible values for a given feature may be represented as a probabilistic distribution.

For example, in a particular application, a neural network could be used to control a robotic system, where the different aspects of the dynamic system such as the state of the system, masses of certain objects, coefficients of friction between objects, and the like are unknown, but can be quantified as being within a certain range as defined by a distribution. Depending on the materials of the objects, the surface treatments of the objects (e.g., polishing, anodizing, etc.), range of tolerances applied to various dimensions of the objects and so forth, the values for different features can fall within the specified ranges given by the distribution.

In some cases, the distribution for a feature can be input to a neural network using representative parameters for the distribution. For example, a random feature with a Gaussian distribution can be represented as a mean and standard deviation, which can be deterministic input features. While using these representative parameters for a normal distribution may work for some problems, it will not work in the general case. For example, problems where the state of the system exhibits a multi-modal distribution cannot be represented accurately by a mean and standard deviation parameter. Thus, there is a need for addressing these issues and/or other issues associated with the prior art.

### SUMMARY

One aspect of the present disclosure provides a method for processing uncertain inputs by a neural network. The method includes: obtaining a distribution, represented by a plurality of samples, for each of one or more features of an input to the neural network, processing the distribution for each of the one or more features by a Reproducing Kernel Hilbert Space (RKHS) module to generate an embedding for the distribution, and processing, by at least one layer of the neural network, the embedding generated for each of the one or more features to generate an output of the neural network.

In accordance with one embodiment of the first aspect, obtaining the distribution for each of the one or more features of the input comprises: executing a plurality of simulator instances to generate the plurality of samples for each of the one or more features. The plurality of samples for a particular feature represents the distribution for the particular feature.

In accordance with one embodiment of the first aspect, the plurality of simulator instances are executed in parallel on a parallel processing unit.

In accordance with one embodiment of the first aspect, the plurality of simulator instances are configured to generate a plurality of distributions for each feature of the one or more features corresponding to discrete time steps of a simulation.

In accordance with one embodiment of the first aspect, the RKHS module is configured to generate the embedding based on a plurality of Random Fourier Features (RFFs).

In accordance with one embodiment of the first aspect, each RFF is generated by determining a random frequency component, ωᵢ, and a random bias component, bᵢ, for the RFF and summing a result of a cosine function applied to each of a plurality of N samples of the distribution. The sum is normalized by the value of N, and the cosine function takes the form: cos(ωᵢx+bᵢ), where i is an index of the RFF associated with a particular dimension of the embedding.

In accordance with one embodiment of the first aspect, a dimension K of the embedding is preset.

In accordance with one embodiment of the first aspect, a dimension K of the embedding and/or frequencies associated with the plurality of RFFs are adjusted dynamically in accordance with an optimization algorithm.

In accordance with one embodiment of the first aspect, the optimization algorithm maximizes the dimension K in accordance with a time constraint associated with processing the embedding by the neural network.

A second aspect of the present disclosure provides a system configured to process uncertain inputs by a neural network. The system includes: a memory, and at least one processor coupled to the memory. The at least one processor is configured to: obtain a distribution for each of one or more features of an input to the neural network, process the distribution for each of the one or more features to generate an embedding for the distribution, and process, by at least one layer of the neural network, the embedding generated for each of the one or more features to generate an output of the neural network.

In accordance with one embodiment of the second aspect, the memory is configured to store parameters for a reproducing kernel Hilbert space (RKHS) module. The parameters include at least one of a plurality of frequency components, ωᵢ, and a plurality of corresponding bias components, bᵢ, for a plurality of Random Fourier Features (RFFs).

In accordance with one embodiment of the second aspect, the embedding is generated based on a plurality of N samples of the distribution applied to the plurality of RFFs.

In accordance with one embodiment of the second aspect, the at least one processor further configured to: execute a plurality of simulator instances to generate a plurality of samples for each of the one or more features. The plurality of samples for a particular feature represents the distribution for the particular feature.

In accordance with one embodiment of the second aspect, the at least one processor comprises: a host processor, and a parallel processing unit. The parallel processing unit is configured to: execute the plurality of simulator instances in a plurality of threads executing in parallel.

In accordance with one embodiment of the second aspect, the parallel processing unit is also configured to implement the neural network.

In accordance with one embodiment of the second aspect, the system further comprises a robotic system. At least one control signal for the robotic system is generated based on the output of the neural network.

In accordance with one embodiment of the second aspect, the system further comprises a vehicle including one or more sensors. The distribution for at least one feature in the input to the neural network is generated by the one or more sensors.

A this aspect of the present disclosure provides a non-transitory computer readable medium storing instructions that, when executed by a processor, cause the processor to perform operations comprising: obtaining a distribution for each of one or more features of an input to the neural network, processing the distribution for each of the one or more features to generate an embedding for the distribution, and processing, by at least one layer of the neural network, the embedding generated for each of the one or more features to generate an output of the neural network.

In accordance with one embodiment of the third aspect, the obtaining the distribution for each of the one or more features of the input comprises: executing a plurality of simulator instances to generate a plurality of samples for each of the one or more features. The plurality of samples for a particular feature represents the distribution for the particular feature.

In accordance with one embodiment of the third aspect, the embedding is generated based on a plurality of Random Fourier Features (RFFs), each RFF associated with a random frequency component, ωᵢ, and a random bias component, bᵢ, for the RFF, and each feature of the embedding is calculated by summing a result of a cosine function applied to each of a plurality of N samples of the distribution. The sum is normalized by the value of N, and the cosine function takes the form: cos(ωᵢx+bᵢ), where i is an index of the RFF associated with a particular dimension of the embedding.

### BRIEF DESCRIPTION OF THE DRAWINGS

The present systems and methods for a utilizing uncertain inputs in inferencing operations performed by a neural network are described in detail below with reference to the attached drawing figures.

FIG. 1 depicts a flow chart of a method for incorporating uncertain features into neural networks, in accordance with some embodiments.

FIG. 2A illustrates a system configured to perform inferencing based on uncertain features, in accordance with an embodiment.

FIG. 2B illustrates a system configured to perform inferencing based on uncertain features, in accordance with another embodiment.

FIG. 3 illustrates a system using uncertain inputs and machine learning as part of a control system, in accordance with some embodiments.

FIG. 4 illustrates an example parallel processing unit suitable for use in implementing some embodiments of the present disclosure.

FIG. 5A is a conceptual diagram of a processing system implemented using the PPU of FIG. 4, suitable for use in implementing some embodiments of the present disclosure.

FIG. 5B illustrates an exemplary system in which the various architecture and/or functionality of the various previous embodiments may be implemented.

FIG. 5C illustrates components of an exemplary system that can be used to train and utilize machine learning, in at least one embodiment.

### DETAILED DESCRIPTION

Systems and methods are disclosed related to incorporating uncertain inputs into a neural network. A distribution is obtained and processed by a Reproducing Kernel Hilbert Space (RKHS) module to generate an embedding that represents the distribution. The embedding can be added to additional input (i.e., features) to form an aggregate input for the neural network. The neural network then processes the aggregate input to generate an output based on, at least in part, the embedding of the distribution.

While neural networks have been designed to process inputs that include statistics or parameters related to a distribution, such as a mean and standard deviation for a Gaussian distribution, the embedding can be used for any distribution represented by a plurality of samples of a variable. This enables the processing of distributions such as multi-modal distributions that are not easily represented by parameters such as a mean and a standard deviation.

Uncertainty exists in the physical world and algorithms can now be designed to use machine learning such as neural networks that can work within the context of these uncertain inputs. For example, a robot designed to use a neural network to generate control signals for actuation of the various axes of the system can utilize information about a distribution of a mass instead of a specific value that merely approximates the controller's best guess as to the actual mass in the system. For example, a robot designed to toss a ball of unknown mass might be controlled by an algorithm of this type, where the mass of the balls has a known distribution but the mass of a particular ball is unknown. This type of control system can then generate an output that is geared towards the possible mass of the components of the systems, which may be unknown, rather than estimating a particular mass for each component. If the estimate of the mass is wrong, then the control system based on uncertain distributions may produce a better output than a system that is configured to use inaccurate estimates for various uncertain parameters.

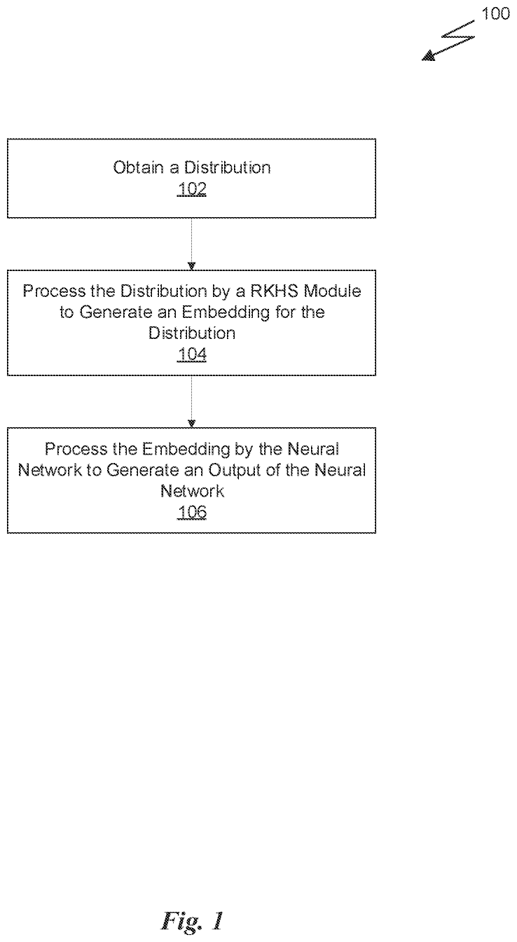

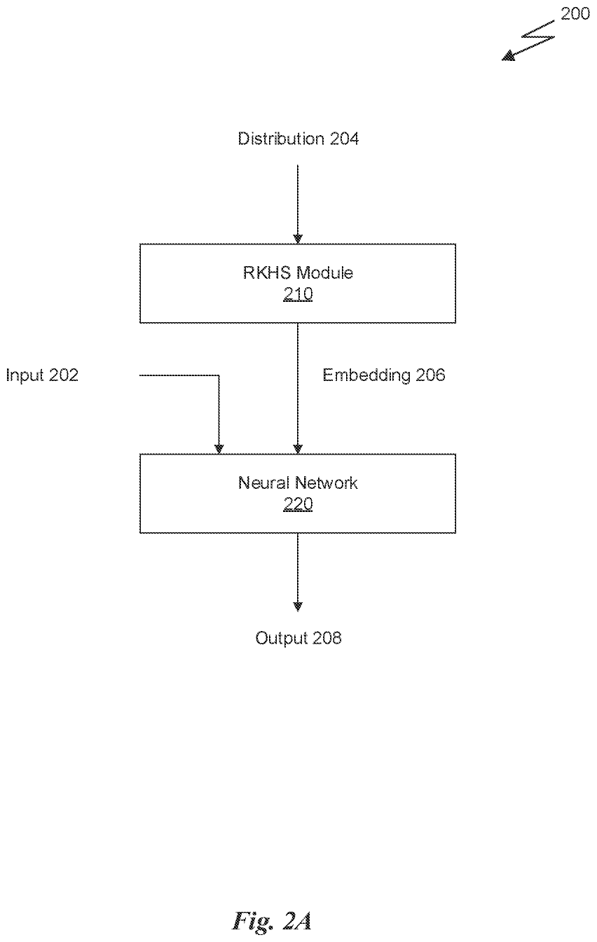

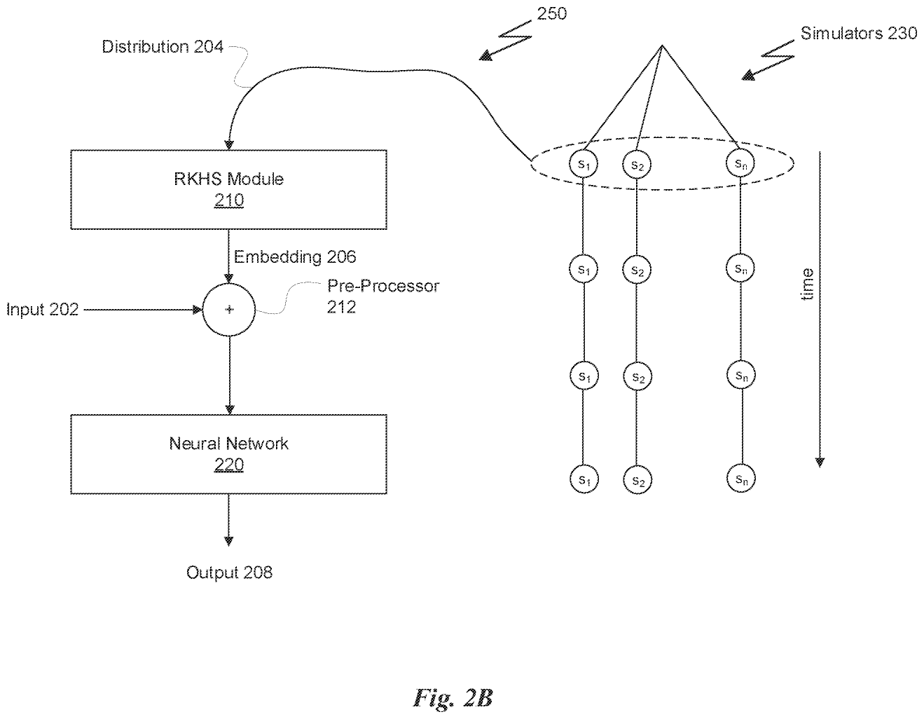

FIG. 1 depicts a flow chart of a method 100 for incorporating uncertain features into neural networks, in accordance with some embodiments. Each block of method 100, described herein, comprises a computing process that may be performed using any combination of hardware, firmware, and/or software. For instance, various functions may be carried out by a processor executing instructions stored in a memory. The method 100 may also be embodied as computer-usable instructions stored on computer storage media. In some embodiments, the method 100 may be provided by a standalone application, a service or hosted service (standalone or in combination with another hosted service), or a plug-in to another product, to name a few possible embodiments. In addition, the method 100 is described, by way of example, with respect to the systems of FIGS. 2A and/or 2B. However, this method 100 may additionally or alternatively be executed by any one system, or any combination of systems, including, but not limited to, those described herein. Furthermore, persons of ordinary skill in the art will understand that any system that performs method 100 is within the scope and spirit of embodiments of the present disclosure.

The method 100 begins at 102, where a distribution is obtained for each of one or more features of an input to the neural network. In an embodiment, the distribution refers to a set of samples for a variable. Each sample is a value for the variable and the set of samples can include n values. In an embodiment, the distribution can be read from a memory. In other words, the n values can be stored in a data structure on a memory device connected to a processor. The processor can read the values by sending a request to the memory device.

In an embodiment, the distribution can be obtained from a separate device. For example, the distribution can be transmitted to the processor via a network and stored in the local memory device associated with the processor. In another embodiment, the processor can generate the distribution. For example, a separate application or process can be executed by the processor to generate a number of samples for the variable. In an embodiment, the application or process can be referred to as a simulator, and a number of simulator instances can be executed in parallel such that each simulator instance generates a discrete value for the variable, which collectively represents the distribution.

In an embodiment, a distribution can be obtained for each of one or more features of an input to a neural network. For example, a distribution for a first variable and a separate distribution for a second variable can be obtained. There is no limit to the number of separate and distinct distributions that can be processed and embedded into an input for a neural network.

At 104, the distribution for each of the one or more features is processed by a Reproducing Kernel Hilbert Space (RKHS) module to generate an embedding for the distribution. In one embodiment, the RKHS module can refer to a set of instructions that is executed by a processor. In another embodiment, the RKHS module can refer to a hardware implementation where a series of accumulators sum values generated by a set of logic gates (e.g., adders, multiplies, etc.) configured to process a sample value in accordance with an equation.

In an embodiment, the RKHS module implements a set of K random Fourier features (RFFs) used to generate a K-dimensional embedding for the distribution. More specifically, each RFF is implemented as a sum of cosines, where each cosine term is calculated according to the following equation:

cos(ωᵢx+bᵢ), (Eq. 1)

where x is a sample value, ωᵢ is a frequency sampled from a distribution of frequencies corresponding to a particular stationary kernel, and bᵢ is a bias parameter. As the name implies, the frequency terms ωᵢ for each component of the embedding can be randomly or pseudo-randomly generated. The bias terms bᵢ can also be randomly or pseudo-randomly generated. The embedding is a vector comprising K values, where each value is generated as a sum of cosine terms calculated in accordance with a set of samples, as follows:

$$\frac{1}{N} [ \begin{matrix}\sum cos ( {ω}_{1} {x}_{j} + {b}_{1} ) \\ \sum cos ( {ω}_{2} {x}_{j} + {b}_{2} ) \\ ⋯ \\ \sum cos ( {ω}_{k} {x}_{j} + {b}_{k} )\end{matrix} ] \qquad ( Eq . 2 )$$

In other words, each sample of the distribution is multiplied by K different frequencies and added to K different bias parameters to generate K parameters to a cosine function. The results of the K cosine functions are then summed with the corresponding results for the other (n−1) samples of the distribution to generate K components of the embedding vector. The embedding vector is then used as a representation of the distribution, and comprises K scalar values in the range [−1, 1]. This procedure corresponds to the kernel mean embedding of a distribution into the RKHS.

It will be appreciated that the choice of dimension K affects the accuracy of the embedding at representing the distribution. If K were selected to be small, then the small number of components of the embedding would not be able to accurately differentiate between different types of distributions. In some embodiments, K may be selected (i.e., preset) to have a magnitude in the tens or hundreds (i.e., the embedding may include tens to hundreds of components).

In some embodiments, K can be set dynamically to provide a better approximation of the underlying RKHS. It will be appreciated that increasing K can add new features to the neural network, which may allow the network to be trained more accurately. However, increasing K can also increase the amount of computations that must be performed to make an inference, which can increase the time or processing capacity required to implement the inferencing function. Further, after a certain point, increasing K will stop improving the approximation of the RKHS and increase computation time, leading to a degradation of efficiency. In some applications that may have specific limitations (e.g., real-time control systems, or embedded systems with limited processing capacity, etc.), K can be adjusted to improve the system within the given constraints. For example, K can be selected based on an optimization algorithm that attempts to maximize the dimension K in accordance with a time constraint associated with processing the embedding the by neural network. In practice, K can be set to an initial value and then, during each time step, the value of K can be adjusted up or down based on the time to complete the processing by the neural network in a previous time step. If the time to complete the processing is above a target value, then K can be decremented to reduce the time to complete the processing, and if the time to complete the processing is below a target value, then K can be incremented to allow for more accuracy in the representation of the distribution while ensuring that the processing is completed within the time constraint. Of course, other types of optimization algorithms can be implemented to adjust the value of K. Furthermore, it will be appreciated that adjusting the value of K, thereby changing the dimension of the embedding, may require corresponding changes to the structure of the neural network to accommodate the new size of the input.

At 106, processing, by at least one layer of the neural network, the embedding generated for each of the one or more features to generate an output of the neural network. In an embodiment, the embedding can be included in an input feature map for the neural network. In other words, the embedding vector output by the RKHS module can be combined with a vector of zero or more other input variables to generate the input for the neural network.

In an embodiment, the neural network can refer to a multi-layer perceptron (MLP) model, a convolutional neural network (CNN), a recurrent neural network (RNN), and the like. In some embodiments, the embedding is processed by an input layer of the neural network. The output of the input layer is processed by one or more hidden layers of the neural network and an output of the last hidden layer is processed by an output layer of the neural network. In other embodiments, the embedding may be processed by one or more of the hidden layers of the neural network. In other words, instead of adding the embedding to other features to be processed by the input layer of the neural network, the embedding is added (e.g., combined, augmented, etc.) to the output of the input layer or one or more of the hidden layers of the neural network to be processed by a subsequent hidden layer or the output layer of the neural network. It will be appreciated that the specific design of the neural network and the location of where the embedding is inserted into the neural network may vary depending on the application.

In some embodiments, the neural network can include two or more neural networks. For example, a portion of the input can be processed by a first neural network and the embedding can be processed by a second neural network. Alternatively, a portion of the input can be processed by a first neural network and the output of the first neural network and the embedding can then be processed by a second neural network. For example, the input can include an image captured by a camera, which is processed by a CNN to generate an output vector representing a classification of the image or features of the image. The output vector can then be combined with the embedding from the RKHS module, which is then processed by a MLP or an RNN. Of course, the output of the MLP or RNN can then be combined with one or more additional features/embedding vectors and processed by a third neural network, and so on and so forth.

Although not shown explicitly in FIG. 1, the method 100 can further incorporate a step for using the output of the neural network in some practical application, such as to control one or more actuators of a robot, control some aspect of a vehicle (e.g., applying the brakes in collision avoidance), or the like. The applications of the output of the neural network to control some system or provide some useful information for a different algorithm are not limited herein and a variety of applications are within the scope of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

FIG. 2A illustrates a system 200 configured to perform inferencing based on uncertain features, in accordance with an embodiment. The system 200 includes a RKHS module 210 and a neural network 220. In an embodiment, a processor is configured to implement one or more of the RKHS module 210 and the neural network 220. In an embodiment, the RKHS module 210 can be implemented on a parallel processing unit configured to execute a plurality of threads in parallel. Each thread can correspond to one RFF of the RKHS module 210. The parallel processing unit can broadcast the value for each sample of a distribution 204 to each thread, which computes a cosine term for that RFF and adds it to a value in an accumulator. Once all of the samples for the distribution 204 have been broadcast to each of the threads, the values in the accumulators can be read out and stored in a memory to generate the embedding 206 for the distribution. In an embodiment, the values in the accumulators can be normalized by dividing each of the values by the number N of samples in the distribution 204.

The embedding 206 can then be provided to the input of a neural network along with one or more additional features included in an input 202. The neural network 220 processes the input 202 and the embedding 206 to generate an output 208 of the neural network 220.

In some embodiments, the processor is a central processing unit (CPU) that can execute one or a small number of threads concurrently (e.g., 2 or 4). The CPU is configured to implement the RKHS module 210 by calculating a value for each RFF sequentially for each sample value received. In yet another embodiment, the processor is an embedded processor such as a reduced instruction set computer (RISC) processor, a microcontroller, a digital signal processor (DSP), a field programmable gate array (FPGA), an application specific integrated circuit (ASIC), or the like. The embedded processor may be single threaded or multithreaded.

In an embodiment, the processor is also configured to execute the neural network 220. In yet other embodiments, the neural network 220 can be implemented by a separate processor, in communication with the processor configured to implement the RKHS module 210. For example, in an embodiment, the processor that implements the RKHS module 210 is a CPU and the separate processor that implements the neural network 220 is a parallel processing unit communicatively coupled to the CPU. In an embodiment, the system 200 includes a system on a chip (SoC) that includes one or more CPU cores and one or more PPU cores.

In yet another embodiment, the processor and the separate processor can be connected via a network, and the neural network 220 can be implemented as a service available via the cloud. In such embodiments, a local processor can generate the embedding 206 and transmit the input 202 and the embedding 206 to the neural network 220 via the network. The neural network 220 processes the input 202 and the embedding 206 to generate the output 208, and the neural network 220 transmits the output 208 back to the local processor via the network. Alternatively, the RKHS module 210 can be implemented as a service available via the cloud, and the local processor can implement the neural network 220. In this case, the local processor can transmit the distribution 204 to the RKHS module 210 via the network, and the RKHS module 210 transmits the embedding 206 back to the local processor via the network. In some embodiments, both the RKHS module 210 and the neural network 220 can be hosted in the cloud.

FIG. 2B illustrates a system 250 configured to perform inferencing based on uncertain features, in accordance with another embodiment. The system 250 includes the RKHS module 210 and the neural network 220 of system 200. However, the system 250 also includes a pre-processor 212 configured to combine the embedding 206 with the input 202 to generate a feature map to be processed by the neural network 220. In an embodiment, the pre-processor 212 can be configured to append the embedding 206 to the input 202.

In some embodiments, the pre-processor 212 can be configured to configure the RKHS module 210 to set parameters such as the dimensionality of the embedding (e.g., set a value of K) and/or generate the frequency and/or bias parameters for the RFFs of the RKHS module 210. In other embodiments, the parameters of the RKHS module 210 may be preset manually or via some type of optimization algorithm that adjusts the parameters to ensure the output of the neural network inferencing operations are meeting some threshold criteria.

In an embodiment, the system 250 also includes a simulator 230 configured to generate samples for a variable. The simulator 230 can refer to a computer program executed by a processor. In an embodiment, a number of simulator instances are instantiated. Each simulator instance can iteratively generate a single sample for each of one or more variables over a number of time steps of a simulation. Each simulator instance can be executed as a thread run on a multi-threaded processor, where N simulator instances produce N samples for a variable during each time step of the simulation. The N samples can be collected for a time step of the simulation and provided to the RKHS module 210 as a distribution 204.

In some embodiments, a simulator can be designed to model the dynamics of a robotic system, where certain variables of the system are unknown. The simulator can be designed so each simulator instance is initiated with a random value for one or more parameters, and the simulator instance models the dynamics of the system over a number of time steps based on those parameters. For example, each simulator instance can randomly select a value for a coefficient of friction between two objects that depends, e.g., on the materials of the objects, a level of surface finish of the objects, and so forth. The simulator can calculate an output for one or more variables (e.g., a position of a mass, or a velocity of a link of the robot, etc.) at each time step, which represents the distribution for those variables due to the random instantiation of the plurality of simulator instances. The RKHS module 210 then converts the distribution 204 of each variable (e.g., a distribution of positions or a distribution of velocities) and generates a corresponding embedding 206 that, combined with any additional input 202, forms the input to the neural network 220. The neural network 220 then generates, e.g., control signals for the actuators of the robotic system or any other task based on the input 202 and/or embedding 206.

As another example of a use case for the system 200, a vision-based system may be implemented where a camera, a light detection and ranging (LiDAR) module, or other optical components are used to image an object or scene. Certain key points on the object or scene can be measured and the key points can be used to generate a distribution that represents an uncertain value (e.g., a position of the object) where each measured distance represents a sample of a measurement. Alternatively, the set of samples represent a sparse data set corresponding to the surface of the object(s), and therefore, the set of samples only provides an uncertain representative sample of the full set of points on the object. The full set of points can be respresented as a distribution related to the set of samples, with some level of uncertainty. Such measurements can be used to create distribution 204 that is input to the RKHS module 210.

As yet another exemplary use case, a system 200 can include a sensor or sensors that generates a point cloud. For example, a LiDAR scanner, which may be fixed or mobile, an image sensor, an inertial measurement unit (IMU), and temperature sensors (e.g., infrared sensors, temperature probes, etc.) or other types of sensors can be combined to capture 3D point data as well as associated data such as color information, temperature information, or other data associated with the point. Point clouds map an area from either a fixed or mobile position, but the resulting point cloud data is typically sparse as object occlusion and/or environmental conditions can sometimes make it difficult to capture a full representation of an object. For example, when generating a point cloud of a room, a coffee table or end table may occlude at least a portion of a couch sitting behind or next to the table. Thus, the generated points may only represent a portion of the surface of the couch. Further, point clouds may sometimes have difficultly distinguishing between objects if the objects are in close proximity or if two surfaces are substantially co-planar and share a similar color or texture.

In such cases, a position of an object may be represented by a distribution of a subset of points in the point cloud, which could be first clustered according to other types of algorithms based on, e.g., image analysis and/or clustering algorithms. The distribution of points, even though it may only represent a sample of points located on a surface of an object, can be used as a distribution of points for the location of the object. In general, a location of the center of an object could be estimated, with some uncertainty, by the average of the locations of points on the surface of the object. Hence, the collection of points from the point cloud data can be used as samples of a distribution that represents the center of the object, with some level of uncertainty because objects are not uniform in shape and because the points in the distribution are only a portion of all points on the surface of the object. Distributions can also be used for other characteristics associated with the point cloud, such as a color of the object or a temperature of the object, given a number of measured samples.

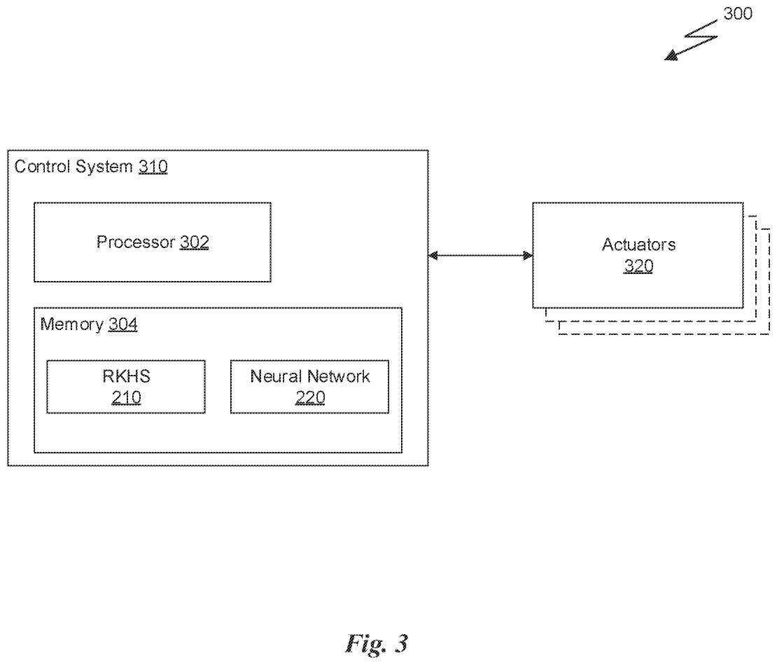

FIG. 3 illustrates a system 300 using uncertain inputs and machine learning as part of a control system, in accordance with some embodiments. The system 300 includes a control system 310 and one or more actuators 320. The control system 310 includes at least one processor 302 and a memory 304, the memory 304 storing program code for implementing the RKHS module 210 and the neural network 220. Although not shown explicitly, the control system 310 may include other common components such as a power supply, a communication module that provides wired or wireless communication capabilities, a display, a keypad, other types of input/output devices, and the like.

In an embodiment, the system 300 is a robotic system with one or more actuators 320. In an embodiment, the robotic system includes a multi-link arm and an end-effector attached to the distal end of a first link of the arm. Each link in the arm can be controlled by one or more actuators. For example, a first actuator can control a relative angle between the link and an adjacent link or a base of the arm, and a second actuator can control a rotation of the link relative to a central axis that runs longitudinally along the long dimension of the link. In an embodiment, the end effector includes a tool, such as a gripper that is configured to open and close to hold an object. Of course, the previous description of the robotic system is only one possible embodiment of the system 300 and different applications can include different structural components and a different number of axes, each axis corresponding to one actuator 320. For example, the end effector can include a welding tool, a drill bit or milling bit attached to a spindle, or the like. The system 300 can also include one or more sensors, such as limit switches, proximity sensors, temperature sensors, current sensors, image sensors, depth sensors, light detection and ranging (LiDAR) sensors, magnetic sensors (e.g., Hall effect sensors), and the like. The system 300 can also include a communication subsystem for wired or wireless communication, as well as one or more processors, memory, and other electronic components.

In an embodiment, the control system 310 implements open loop or closed loop control of the robotic system using the RKHS module 210 and the neural network 220. For each time step in a control loop, the control system 310 may collect input data and/or obtain, via the simulator 230 or otherwise, a distribution for one or more features that are used to provide the input to the neural network 220. The neural network 220 may be trained for a particular task using a set of training data and any well-known supervised or unsupervised training technique known to those of skill in the art. Once trained, the neural network 220 performs inferencing based on an embedding 206 generated by the RKHS module 210 in accordance with the distribution 204, as described above.

In other embodiments, the system 300 is a vehicle, and the control system 310 is included in the vehicle. The neural network 220 may be trained to perform inferencing to control one or more aspects of the vehicle. For example, the neural network 220 can be included in an crash avoidance system to monitor a state of the vehicle and automatically apply brakes to avoid striking an object. The input to the neural network 220 can include, e.g., camera or LiDAR data captured by sensors on the vehicle. The input to the neural network 220 can also include embeddings based on distributions for such parameters as tire diameter, tire material properties (e.g., whether the tire is soft or hard), coefficient of friction between the tire and the road, road conditions (e.g., whether the road is wet), and so forth. It will be appreciated that using a distribution for these parameters may be necessary because vehicle owners may frequently place after-market parts on their vehicle that change the dynamics of the system. Further, while a rain sensor may detect the presence of water, thus skewing the coefficient of friction between the tire and the road compared to dry conditions, the exact effect of the rain on the coefficient of friction may be unknown due to conditions in the road such as drainage due to the slope of the road, texture of the road surface, presence of oils or other residues on the road, and the like. In an embodiment, the distribution for at least one feature in the input to the neural network is generated by the one or more sensors included in the vehicle. The simulators 230 can be used to simulate various road conditions and generate distributions for these parameters across a spectrum of different scenarios, which can then be used by the control system to generate the embedding based on the distribution. These embeddings allow for the neural network to be trained for a distribution associated with these parameter rather than a specific value, and the output of the neural network 220 can then take into account the uncertainty for these particular features.

As another example, in the crash avoidance scenario described above, it may be possible to anticipate the motion of objects into a path of the vehicle better using a distribution related to an estimated future position of an object. Simulations can model random paths of a person on the sidewalk to determine a distribution of the position of that person relative to the current path of the vehicle. While the most likely scenario is that the person may continue walking in a straight path on the trajectory the person is headed, there is a chance that the person could change directions and turn out into the road at a point when the vehicle is moving too fast to avoid a collision. By modeling the behavior of the person, the vehicle can anticipate the likelihood that the person will move into the path of the vehicle and adjust a speed or trajectory of the vehicle accordingly to account for such probabilities. Thus, the uncertain inputs represented by the distribution may be better at allowing the control system to anticipate events based on their probabilities and the distribution can be derived, based at least in part, on input from sensors included in the vehicle, such as an image sensor or LiDAR sensor used to detect the position and/or trajectory of an object proximate the vehicle.

It will be appreciated that the system 300 is not limited to robotic systems or vehicles and that any system that can be controlled by control signals generated by the control system 310 is within the scope of the present disclosure. Furthermore, the vehicle is not limited to cars, trucks, buses, and the like, but can include aerial vehicles (e.g., airplanes, UAVs, etc.) as well as water-based vehicles (e.g., boats, ships, submarines, etc.).

In some embodiments, the RKHS module 210 and/or the neural network 220 can be implemented by one or more processors, including a central processing unit (CPU) (e.g., a host processor) and/or a parallel processing unit (PPU) configured to work in tandem. More details regarding an exemplary architecture of a PPU 400 configured to implement the aforementioned framework is set forth below.

### Parallel Processing Architecture

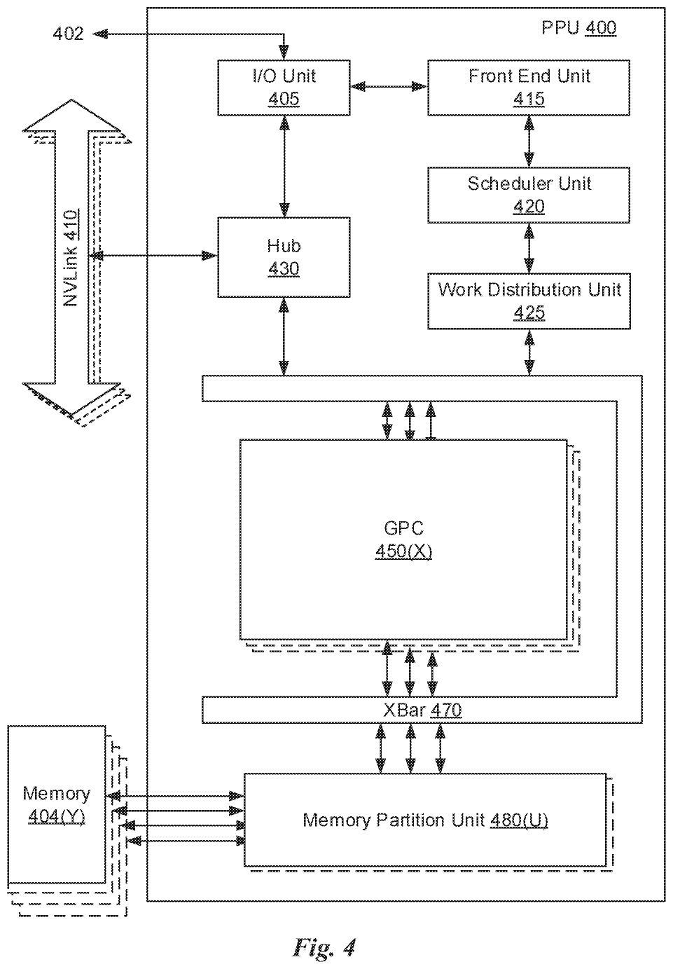

FIG. 4 illustrates a parallel processing unit (PPU) 400, in accordance with an embodiment. In an embodiment, a processor such as the PPU 400 may be configured to implement a neural network model. The neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

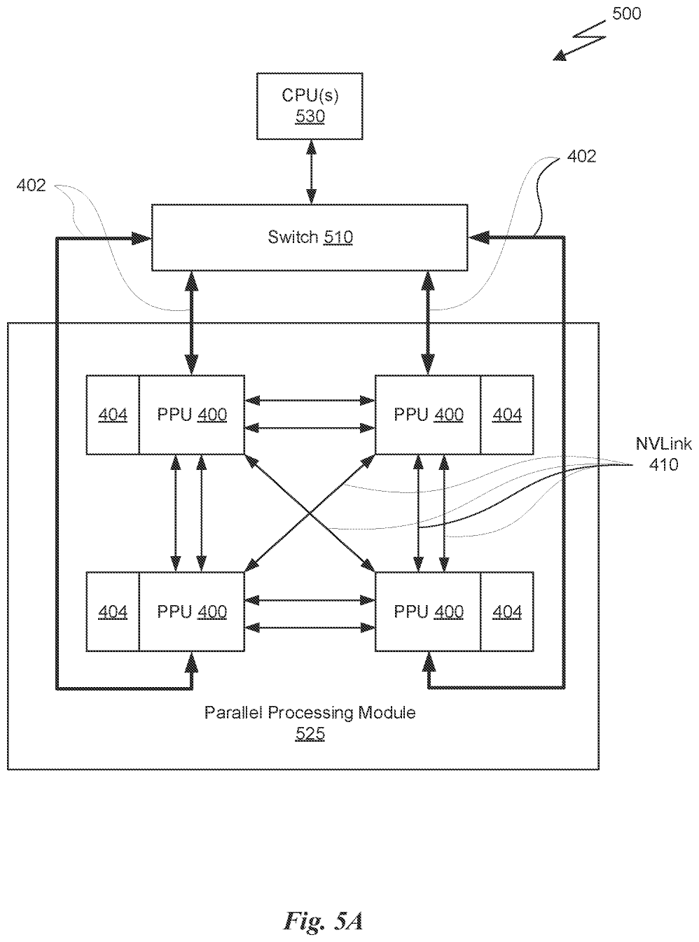

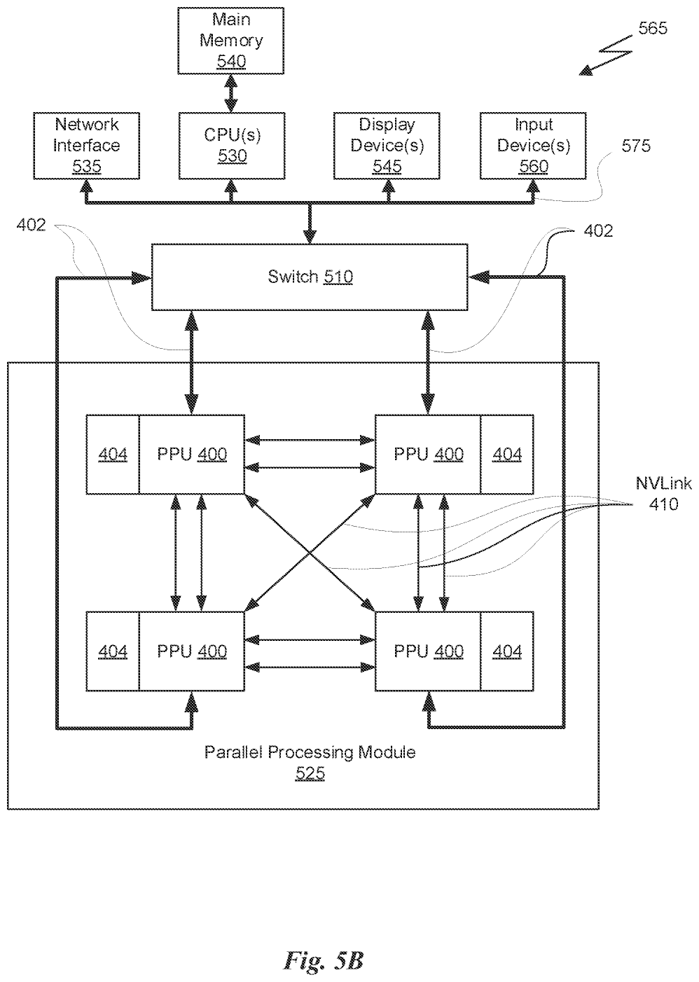

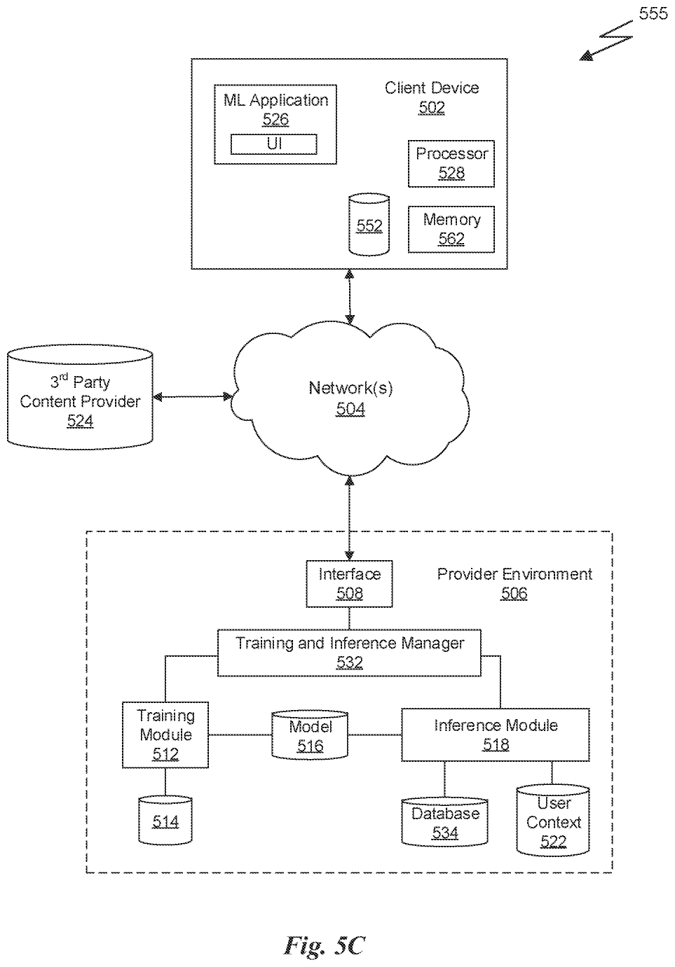

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The exemplary system 500 may be configured to implement the method 100 shown in FIG. 1. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured to implement the method 100 shown in FIG. 1.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5B are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5B.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5A and/or exemplary system 565 of FIG. 5B. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 300 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

1. A method for processing uncertain inputs by a neural network, the method comprising:
obtaining a distribution, represented by a plurality of samples, for each of one or more features of an input to the neural network;
processing the distribution for each of the one or more features by a Reproducing Kernel Hilbert Space (RKHS) module to generate an embedding for the distribution; and
processing, by at least one layer of the neural network, the embedding generated for each of the one or more features to generate an output of the neural network.

2. The method of claim 1, wherein the obtaining the distribution for each of the one or more features of the input comprises:
executing a plurality of simulator instances to generate the plurality of samples for each of the one or more features, wherein the plurality of samples for a particular feature represents the distribution for the particular feature.

3. The method of claim 2, wherein the plurality of simulator instances are executed in parallel on a parallel processing unit.

4. The method of claim 2, wherein the plurality of simulator instances are configured to generate a plurality of distributions for each feature of the one or more features corresponding to discrete time steps of a simulation.

5. The method of claim 1, wherein the RKHS module is configured to generate the embedding based on a plurality of Random Fourier Features (RFFs).

6. The method of claim 5, wherein each RFF is generated by determining a random frequency component, ωᵢ, and a random bias component, bᵢ, for the RFF and summing a result of a cosine function applied to each of a plurality of N samples of the distribution, wherein the sum is normalized by the value of N, and the cosine function takes the form:
cos(ωᵢx+bᵢ),
where i is an index of the RFF associated with a particular dimension of the embedding.

7. The method of claim 5, wherein a dimension K of the embedding is preset.

8. The method of claim 5, wherein a dimension K of the embedding and/or frequencies associated with the plurality of RFFs are adjusted dynamically in accordance with an optimization algorithm.

9. The method of claim 8, wherein the optimization algorithm maximizes the dimension K in accordance with a time constraint associated with processing the embedding by the neural network.

10. A system configured to process uncertain inputs by a neural network, the system comprising:
a memory; and
at least one processor coupled to the memory and configured to:
obtain a distribution for each of one or more features of an input to the neural network,
process the distribution for each of the one or more features to generate an embedding for the distribution, and
process, by at least one layer of the neural network, the embedding generated for each of the one or more features to generate an output of the neural network.

11. The system of claim 10, wherein the memory is configured to store parameters for a reproducing kernel Hilbert space (RKHS) module, the parameters including at least one of a plurality of frequency components, ωᵢ, and a plurality of corresponding bias components, bᵢ, for a plurality of Random Fourier Features (RFFs).

12. The system of claim 11, wherein the embedding is generated based on a plurality of N samples of the distribution applied to the plurality of RFFs.

13. The system of claim 10, the at least one processor further configured to:
execute a plurality of simulator instances to generate a plurality of samples for each of the one or more features, wherein the plurality of samples for a particular feature represents the distribution for the particular feature.

14. The system of claim 11, wherein the at least one processor comprises:
a host processor; and
a parallel processing unit configured to execute the plurality of simulator instances in a plurality of threads executing in parallel.

15. The system of claim 14, wherein the parallel processing unit is also configured to implement the neural network.

16. The system of claim 10, further comprising a robotic system, wherein at least one control signal for the robotic system is generated based on the output of the neural network.

17. The system of claim 10, further comprising a vehicle including one or more sensors, and wherein the distribution for at least one feature in the input to the neural network is generated by the one or more sensors.

18. A non-transitory computer readable medium storing instructions that, when executed by a processor, cause the processor to perform operations comprising:
obtaining a distribution for each of one or more features of an input to the neural network;
processing the distribution for each of the one or more features to generate an embedding for the distribution; and
processing, by at least one layer of the neural network, the embedding generated for each of the one or more features to generate an output of the neural network.

19. The non-transitory computer readable medium of claim 18, wherein the obtaining the distribution for each of the one or more features of the input comprises:
executing a plurality of simulator instances to generate a plurality of samples for each of the one or more features, wherein the plurality of samples for a particular feature represents the distribution for the particular feature.

20. The non-transitory computer readable medium of claim 18, wherein the embedding is generated based on a plurality of Random Fourier Features (RFFs), each RFF associated with a random frequency component, ωᵢ, and a random bias component, bᵢ, for the RFF, and each feature of the embedding is calculated by summing a result of a cosine function applied to each of a plurality of N samples of the distribution, wherein the sum is normalized by the value of N, and the cosine function takes the form:
cos(ωᵢx+bᵢ),
where i is an index of the RFF associated with a particular dimension of the embedding.
